(19) United States
(12) Patent Application Publication
(10) Pub. No.: US 2008/0207233 A1
(43) Pub. Date: Aug. 28, 2008

(54) Method and System For Centralized Storage of Media and for Communication of Such Media Activated By Real-Time Messaging

(76) Inventors: William L. Waytena, San Francisco, CA (US); Eric T. Stone, San Francisco, CA (US)

Correspondence Address: GORDON & JACOBSON, P.C., 60 LONG RIDGE ROAD, SUITE 407, STAMFORD, CT, 06902, US

(21) Appl. No.: 11/680,291

(22) Filed: Feb. 28, 2007

(51) Int. Cl. H04Q 7/20

(52) U.S. Cl. 455/466

(57) ABSTRACT

An apparatus and methodology are provided that initiates on-demand communication of media content in response to receipt of text-based messages. The text-based messages can have a plurality of diverse messaging formats. Each text-based message encapsulates text conforming to a predefined syntax that includes a content text field representing an identifier for media content to be accessed as part of the on-demand communication and preferably at least one target text field representing a recipient of the on-demand communication. Database storage stores identifiers and associated references to media content and preferably short names and associated contact information (e.g., telephone numbers and IM user names). The content text field and the target text field(s) are expected to match the identifiers and short names, respectively, stored in the database. The text is extracted from each received text-based message and parsed to identify the content text field and the at least one target text field therein. The database is accessed to retrieve references to media content associated with the identifier corresponding to the content text field. The database is also preferably accessed to retrieve contact information associated with a short name corresponding to the at least one target text field. The on-demand communication is established utilizing the media content references (and the contact information) retrieved from the database. The diverse messaging formats supported by the system preferably include SMS-type text-based messages, IM-type text-based messages, and IP-type text-based messages that are addressed to a reserved IP address.

### BACKGROUND OF THE INVENTION

1. Field of the Invention

This invention relates broadly to telecommunication methods and systems. More particularly, this invention relates to services that provide for centralized management of media content and for on-demand communication of such media to user-operated communication terminals.

2. State of the Art

Media content including audio (such as music songs, podcasts and the like) and still images (such as photos) are typically shared by users on a peer-to-peer basis (or peer-to-group basis) over e-mail or internet messaging. Users must typically wait for the exchange to be complete before accessing the file. This wait, which stems from the latency of the underlying communication network, can be substantial for the larger file sizes of the audio content and still image content that is typically shared. Such delay issues are exasperated for user's exchanging video content due to the larger file sizes of the video content that is typically shared. In addition, the communication devices for carrying out such sharing typically store the shared content on hard disk drives or other forms of persistent data storage which are bulky and expensive. For this reason, the communication terminals that carry out such sharing are typically fixed and non-portable, which limits the ability of user to perform such sharing to fixed and non-portable environments.

Advanced cellular services have introduced technology that assisted customers' needs for availability and receipt of instantaneous information. One such technology, known as Short Messaging Service (SMS), enables individuals to send and receive short text messages on mobile phones and other mobile devices (and occasionally even on computers). SMS was developed in Europe in the early 1990s. Initially, SMS was available as part of GSM networks; however, it is now available on a wide range of networks, including CDMA and 3G networks. SMS is a point-to-point communication method whereby an SMS message is transmitted from a wireless phone (or other mobile device or possibly a computer) to a short message service center (SMS-C), which acts as a store and forward system for short messages. The message is forwarded from the SMS-C to the destination phone (or other mobile device or possibly a computer).

A service known as “Upsnap™” has recently been made introduced. The service enables a user to utilize an SMS message to access stored audio content (more particularly, a podcast) and play the podcast over a connection between the service and the user's mobile phone. More particularly, users add podcasts to user-specific playlists that are maintained by the service. A user sends an SMS message “POD” to the reserved number for the service. The service returns an SMS message that enables user selection of one of the podcasts within the user's playlist. Once connected, the service plays the selected podcast. The service also provides access to audio streams from a variety of radio channels. The audio streams can be accessed in one of three ways:
i) Dial-up: the user dials a phone number and follows a series of voice prompts to choose the content that they wish to hear; this requires the user to know the unique 4-digit station code for each station to which they want to listen;
ii) Wireless Internet: the user points their cell phone's browser to one of UpSNAP's wireless Internet (WAP) URLs and navigates through the content menu to select the desired audio stream; and
iii) SMS messaging: the user sends a key word for the station or service that the user wishes to access to UpSNAP's short code (27627); the user then receives a text message that, depending on the station/service being requested, contains either additional instructions, station options or an embedded phone number to connect the user to the audio stream; the user then responds accordingly to access the desired audio content or service; using the SMS/Text messaging interface requires the user to know the unique key word for the station or service to which they wish to listen.
   Although the “Upsnap™” service provides enhanced services, it suffers from several shortcomings. First, the audio content that is played by the service during a particular phone call is dictated by user interaction with the one of several selection interfaces. These selection interfaces are cumbersome and time consuming to navigate, especially in those instances where the user must navigate through a large number of audio content items for selecting a particular audio content item. Second, the service supports only SMS-type messaging (not IM messaging or other messaging platforms) for the activation of audio content streaming to the user. Third, the service does not allow for users to share content. Instead, individual users must navigate through the audio content selection interface of the service user to access the desired audio content. Finally, the content made accessible to users of the service is controlled solely by the service. These shortcomings can limit potential adoption and success of the service.

### SUMMARY OF THE INVENTION

It is therefore an object of the invention to provide an apparatus and methodology for on-demand access and communication of media content in response to text-based messages, where it is quick, easy and convenient for users to specify the media content as part of the text message, and where there is minimal delay in carrying out such communication.

It is another object of the invention to provide such an apparatus and methodology for sharing media content, where it is quick, easy and convenient for users to specify the intended recipient of the media content as part of the text message.

It is another object of the invention to provide such an apparatus and methodology whereby the content that is made accessible to users of the service can be controlled by individual users.

It is yet another object of the invention to provide such an apparatus and methodology which supports diverse messaging formats.

In accord with these objects, which will be discussed in detail below, an apparatus and methodology are provided that initiates on-demand communication of media content in response to receipt of text-based messages. The text-based messages can have a plurality of diverse messaging formats. Each text-based message encapsulates text conforming to a predefined syntax that includes a content text field representing an identifier for media content to be accessed as part of the on-demand communication and preferably at least one target text field representing a recipient of the on-demand communication. Database storage stores identifiers and associated references to media content and preferably short names and associated contact information (e.g., telephone numbers and IM user names). The content text field and the target text field(s) are expected to match the identifiers and short names, respectively, stored in the database. The text is extracted from each received text-based message and parsed to identify the content text field and the at least one target text field therein. The database is accessed to retrieve references to media content associated with the identifier corresponding to the content text field. The database is also preferably accessed to retrieve contact information associated with a short name corresponding to the at least one target text field. The on-demand communication is established utilizing the media content references (and the contact information) retrieved from the database. The diverse messaging formats supported by the system preferably include SMS-type text-based messages, IM-type text-based messages, and IP-type text-based messages that are addressed to a reserved IP address.

It is preferred that the predefined syntax of the text-based messages include at least one command text field representing a predefined command. The parsing of the text of each received text-based message confirms that it includes the command text field therein.

It is contemplated that the command text field and/or the target text field of the text-based message can be omitted. For example, the target text field can be omitted where there is a particular destination short code or address associated with a particular command, or where the recipient of the on-demand communication is identified from the originating telephone number of the text-based message. In another example, the command text field can be omitted where the content text field implies or is otherwise associated with a certain command or where the recipient short code or other recipient address of the text-based message implies or is otherwise associated with a certain command.

It is also contemplated that the context text field of the text-based message can represent other information used as part of the on-demand communication. For example, the content text field can identify the media content to be accessed as part of the on-demand communication as well as the recipient of such on-demand communication. In such a system, the context text field combines a media content identifier and recipient identifier into one code. In another example, the content text field can identify the media content to be accessed as part of the on-demand communication as well as a command identifier for such on-demand communication. In such a system, the context text field combines a media content identifier and command identifier into one code. In yet another example, the content text field can identify the media content to be accessed as part of the on-demand communication, the recipient of such on-demand communication, and a command identifier for such on-demand communication. In such a system, the context text field combines a media content identifier, a recipient identifier and command identifier into one code.

In the preferred embodiment, each text-based message is addressed to a predetermined identifier, which can be one of the following: a reserved telephone number for SMS-type text-based messages, a reserved IM short name and IM Service Provider for IM-type text-based messaging, and a reserved IP address and port for IP-type text-based messages. The apparatus includes corresponding interfaces, such as a gateway for receiving SMS-type text-based messages addressed to the reserved telephone number for SMS-type text-based messages, a gateway for receiving IM-type text-based messages addressed to the reserved IM short name and IM Service Provider, and an IP Monitor for receiving IP-type text-based messages addressed to the reserved IP address and port for IP-type text-based messages.

In the preferred embodiment, the media content associated with a given playlist name can be uploaded by a user and stored in the database managed by the service. The service also maintains media content that is controlled by the service. Such service-controlled media content can be stored by the service or otherwise made accessible to users of the service. Permissions can be used to dictate access to the media content.

In the preferred embodiment, media content search and browse functionality can be provided to enable a user to identify the media content that is accessible by the user and add one or more selected media content items to a playlist name.

Additional objects and advantages of the invention will become apparent to those skilled in the art upon reference to the detailed description taken in conjunction with the provided figures.

### BRIEF DESCRIPTION OF THE DRAWINGS

FIG. 1 is a schematic diagram of an embodiment of a communication system in accordance with the present invention.

FIG. 2A is a schematic diagram of a mobile telephony device of FIG. 1.

FIG. 2B is a schematic diagram of another mobile telephony device of FIG. 1.

FIG. 2C is a schematic diagram of a communication terminal of FIG. 1.

FIG. 2D is a schematic diagram of another communication terminal of FIG. 1.

FIG. 3 is a schematic diagram of an alternate embodiment of a communication system in accordance with the present invention.

### DETAILED DESCRIPTION OF THE PREFERRED EMBODIMENTS

As used herein, the term “telecommunication” is generally defined as the transmission and reception of signals over a distance for the purpose of communication. A “telephony device” (or “telephony terminal” or “telephone”) is generally defined as a telecommunications device which is used to transmit and receive sound (most commonly voice and speech) across distance. A “communications device” (or “communications terminal”) is a device that transmits and receives signals for the purpose of communication.

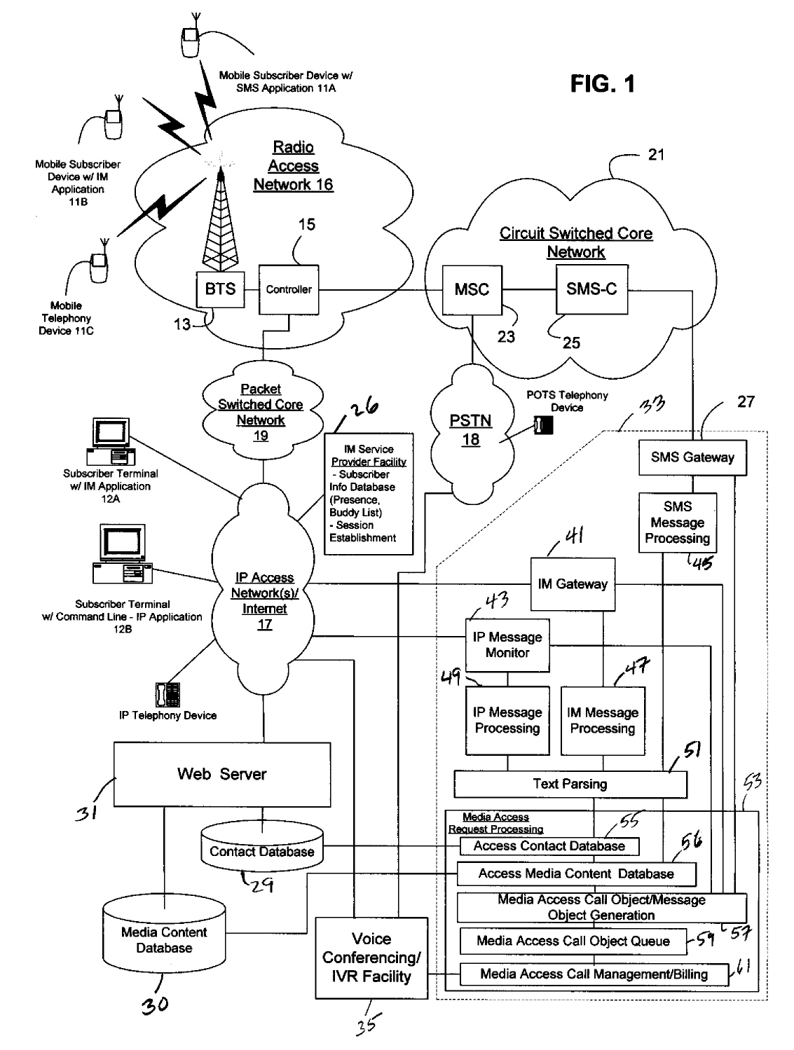

Turning now to FIG. 1, there is shown a schematic diagram of an exemplary telecommunication system in which the present invention is embodied. Mobile telephony devices 11 communicate over wireless communication links to a mobile access network 16, which includes a plurality of base stations 13 (one shown) that are operably coupled to controllers 15 (one shown). The controllers 15 are responsible for radio resource allocation to the mobile telephony devices 11, and for frequency administration and handover between base stations 13. The controller function may be physically located within a base station 13 itself. Each base station 13 includes at least one antenna and a group of one or more radio transmitter-receiver pairs. Each transmitter-receiver pair operates on a pair of radio frequencies to create a communication channel: one frequency to transmit radio signals to a mobile telephony device 11 and the other frequency to receive radio signals from the mobile telephony device 11. Each base station 13 defines a cell of the mobile access network 16, which is a predetermined volume of space radially arranged around its antenna. In order to prevent the radio signals transmitted from one base station from interfering with radio signals transmitted from an adjacent base station, the transmitter frequencies for adjacent base stations are selected to be different so that there is sufficient frequency separation between adjacent transmitter frequencies. In order to reuse the same frequencies, the cellular telecommunication industry has developed a small but finite number of transmitter frequencies and allocation patterns that ensure that adjacent cell sites do not operate on the same frequency. When a mobile telephony device 11 initiates a call connection, control signals transmitted from the local base station 13 cause the frequency agile transponder in the mobile telephony device 11 to operate at the frequency of operation designated for that particular base station. As the mobile telephony device 11 moves from one cell to another, the call connection is handed off to the successive base station and the frequency agile transponder in the mobile telephony device 11 adjusts its frequency of operation to correspond to the frequency of operation of the base station 13 located in the cell in which the mobile telephony device 11 is presently operational.

Fixed or mobile communication terminals 12 communicate over communication links to the IP access network(s)/Internet 17 as is well known. Such communication can be carried out by a cable modem coupled to a hybrid fiber coax data network, a DSL modem coupled to a DSL access network, or a radio interface coupled to a Wi-Fi or Wi-Max access network. The fixed or mobile communication terminals 12 can be any of a number of communication devices including personal computers, laptop computers, personal digital assistants, networked kiosks, VOIP phones, traditional phones connected to VOIP gateways, and the like.

The mobile access network 16 interfaces to a packet switched core network 19 and to a circuit switched core network 21. Packet switched traffic (e.g., IP packet data) that originates from (or is destined to) the mobile telephony devices 11 is routed over the packet switched core network 19. Circuit switched traffic (e.g., voice calls, SMS messages) that originates from (or is destined to) the mobile telephony devices 11 is routed over the circuit switched core network 21.

The packet switched core network 19 connects to the Internet 27 and includes functionality for data session management of the mobile telephony devices 11 and for routing packet switched traffic into and out of the packet switched core network 19. In this manner, the packet switched core network enables the mobile telephony devices 11 to connect to Internet-connected devices (e.g., a web server, a VOIP communication terminal, etc.) as needed.

The circuit switched core network 21 includes a mobile switching center (MSC) 23 and an SMS center (SMS-C) 25. Generally, the MSC 23 connects the circuit switched core network 21 to the public switched telephone network 18 and manages and routes circuit switched voice traffic into and out of the circuit switched core network 21. In this manner, the MSC 23 enables the mobile telephony devices 11 to connect to POTS telephony devices that interface to the PSTN 18 as needed.

The SMS-C 25 functions as a centralized store-and-forward device that accepts SMS messages and buffers the received SMS messages until a suitable delivery time (e.g., the destination mobile telephony device 11 is powered on and the location known). The SMS-C 25 also provides an interface in accordance with a communication protocol (e.g., UCP, SMPP, Sema OIS, CIMD2) that allows for communication of SMS messages to and from other cell networks and to and from other external SMS processing devices (e.g., the SMS gateway 27). Preferably, the external SMS processing device(s) is (are) connected to the SMS-C 25 over a wide area network such as the Internet.

Numerous technologies, such as GSM, CDMA, EDGE and W-CDMA technology, can be used to implement the mobile access network 16 and the supporting core networks 19 and 21. GSM technologies provide GPRS services which can be used for packet switched applications. 3G CDMA technologies provide code division multiplexing technology for packet switched applications. EDGE technology provides enhanced GPRS services. High-speed data applications such as video services and other multimedia services benefit from the increased data capacity provided by the enhanced GPRS services. W-CDMA technology employs wideband code division multiplexing technology to provide high speed packet switched data rates that is suitable for high-speed data applications such as video services and other multimedia services.

The communication system of FIG. 1 supports a service for centralized management of media content and for on-demand communication of such media to user-operated communication terminals. The on-demand communication is activated by the receipt of messages conforming to one or more diverse messaging formats. In the preferred embodiment, the diverse messaging formats include a Short Message Service (SMS) messaging format, an Instant Message (IM) messaging format, and a proprietary IP messaging format.

The SMS messaging format, which is specified by the ETSI organization (documents GSM 03.40 and GSM 03.38), can be up to 160 characters long, where each character is 7 bits according to the 7-bit default alphabet. An eight-bit message format (max 140 characters) can also be used, but this format is usually not viewable by the phones as text messages; instead it is used for data in smart messaging (images and ringing tones) and OTA provisioning of WAP settings. A 16-bit message format (max 70 characters) can also be used for Unicode (UCS2) text messages and is viewable by most phones. There are two ways of sending and receiving SMS messages: by a protocol description unit (PDU) mode or by a text mode. The PDU mode contains not only the text of the message, but also a lot of meta-information about the sender (e.g., the sender's SMS service center, the time stamp, etc). The text mode is just an encoding of the bit stream represented by the PDU mode. Alphabets may differ and there are several encoding alternatives when displaying an SMS message. The most common options are “PCCP437”, “PCDN”, “8859-1”, “IRA” and “GSM”. These options are set by the at-command AT+CSCS. An application capable of reading incoming SMS messages, can thus use text mode or PDU mode. If text mode is used, the application is bound to (or limited by) the set of preset encoding options. If PDU mode is used, any encoding can be implemented.

Instant messages are generated by applications for carrying out text conversations that are to happen in real-time. Instant message service providers (e.g., AOL Instant Messenger, Yahoo! Messenger, Skype, Google Talk, Windows Messenger, ICQ, etc.) typically maintain a facility 26 that includes a database storing a list of contacts for each subscriber and presence information. The presence information indicates the availability of the contacts. Most instant messaging service providers allow users to set and update their presence information so that peers get notified whenever the user is available, busy, or away. The facility 26 also includes logic that establishes communication sessions between subscribers (or between a subscriber and a user of another provider). The facility 26 typically employs proprietary protocols for maintaining presence information and receiving notifications related thereto (for example, a notification when a user logs-in or comes back from lunch), for managing a session of real-time messages between two or more participants, and for communicating such real time messages between the two or more participants of a given session. The message format for the real-time messages communicated between the participants of a given session is typically proprietary in nature and thus can vary between service providers. Standards-based protocols for instant messaging, such as XMPP and Jingle (defined at http://www.xmpp.org/extensions/xep-0166.html) can also be used.

Subscribers of the service access a database 29. Each subscriber can have the following information associated therewith in the database 29:

the user name of the subscriber;

a password and possibly other information for authentication of the subscriber;

at least one phone number for the subscriber, which can the number assigned to the subscriber's traditional POTS telephony device for home or business purposes, a number assigned to the subscriber's mobile telephony device, an identifier assigned to the subscriber's IP telephony device, or other identifier that is used to establish a voice connection to the subscriber;

at least one IM screen name/IM Service Provider for the subscriber, which is used to route IM messages and possibly for establishing a voice connection to the subscriber;

at least one email address for the subscriber;

a home address for the subscriber; and

a business address for the subscriber.

Subscribers can add and modify a list of contacts for the subscriber. The list is stored in the database 29. The following information can be associated with a given contact in the subscriber's contact list:

a short name for the contact;

at least one phone number for the contact, which can the number assigned to the contact's traditional POTS telephony device for home or business purposes, a number assigned to the contact's mobile telephony device, an identifier assigned to the contact's IP telephony device, or other identifier that is used to establish a voice connection to the contact;

at least one IM screen name/IM Service Provider for the contact, which is used to route IM messages and possibly for establishing a voice connection to the contact;

at least one email address for the contact;

a home address for the contact; and

a business address for the contact.

The database 29 can also include a calendar for each subscriber, which includes events, appointments, to-dos, and other information input by the subscriber as being associated with particular dates and times.

Subscriber's can also upload media content to a content database 30. The media content can be music files or other audio files (such as podcasts and the like), still-image files (such as photos and the like), video files or other multimedia files (such as home video recordings and the like), three-dimensional data and the like, and/or other forms of audio and/or visual information. The upload files can be analyzed by a process for automatic file identification. For example, the service can access the Gracenote™ service (or other online database service) for automatic identification of uploaded digital music files and the tag data associated therewith.

The service can also maintain media content that are controlled by the service. Such service-controlled media content can be music files or other audio files (such as podcasts and the like), still-image files (such as photos and the like), video files or other multimedia files (such as home video recordings and the like), three-dimensional data and the like, and/or other forms of audio and/or visual information. The service-controlled media content can be stored in the content database 30 or otherwise made accessible to users of the service.

Subscribers can create playlists, which are lists of one or more media content items stored or accessible by the service, and can assign identifiers o such playlists. Similarly, the service can create playlists and can assign identifiers to such playlists. These playlists can refer to user-uploaded media content items as well as service-controlled media content items. The identifiers for such playlists (which are also referred to herein as “playlist names”, “content codes” or “codes”) are preferably realized by alphanumeric strings. The playlist names for user-defined playlists preferably are arbitrarily assigned to one or more media content items by users of the system in accordance with a predetermined naming convention (which can limit the length of the name and/or specify other constraints). The playlist names for service-defined playlists preferably are uniquely assigned to one or more media content items in accordance with a predetermined naming convention. The playlist names and references to the corresponding media content items (e.g., file names) of the playlists are stored in the contact database 29. The playlist names maintained by the service allow for quick, easy and convenient sharing of the media content items associated therewith as described below in detail.

Moreover, the user-defined playlists and service-defined playlists can be communicated between users of the service, for example, over a playlist sharing interface provided to users of the service. Alternatively, a playlist can be encapsulated as part of an XML data structure or other data structure and communicated between users (for example, over IM messaging, email, downloaded from a web page). The playlist data structure is then uploaded to the service by the recipient user. In this manner, the service can allow for quick, easy and convenient sharing of such playlists.

Permissions can be used to dictate access to the user-uploaded media content as well as the service-controlled media content stored in the content database 30. Such permissions can be configured in many ways, such as public access, group access, individual user access, etc. Such permissions can be configured to allow for public access to the media content whereby all users of the service can refer to the particular media content as part of a playlist for on-demand communication of such media content. Such permissions can also be configured to allow for group access to the media content whereby users of the service that belong to the specified group can refer to the particular media content as part of a playlist for on-demand communication of such media content. Such permission can also be configured to allow for individual user access to media content whereby a specified individual user can refer to the particular media content as part of a playlist for on-demand communication of such media content. One of more of such permissions can be linked to particular media content to provide a complex set of permissions that control access to the media content.

Subscriber's access to the databases 29 and 30 can be accomplished over the Internet with a web server (or application server) 31 that provides an interface therebetween. This configuration allows users to access, update and manage the databases 29, 30 via user interaction with a web browser in communication with the web server (or application server) 31 over the Internet. The web browser can be executing on one of the Internet-connect fixed or mobile communication terminals 12. Alternatively, it can be a micro-browser executing on one of the mobile telephony devices 11. In other embodiments, subscriber access to the databases 29 and 30 can be realized by other communication means, such as messages directed to the service over any one of the diverse messaging formats supported by the service, interaction with an IVR system managed by the service, and/or other means. Media content search and browse functionality can be provided to enable a user to identify the media content that is accessible by the user and add one or more selected media content items to a given playlist name.

On-demand communication of the media content is activated in response to receiving a message conforming to one of the diverse messaging formats supported by the service. The message (which is referred to below as a media access request message) is communicated from a subscriber-operated communication device, which can be one of the mobile telephony devices 11 or one of the fixed or mobile communication terminals 12. The media access request message encapsulates plain text with a predetermined command syntax that includes the following:

i) text that identifies the message as a particular command for requesting on-demand communication of the media content stored in the content database 30;

ii) text that identifies one or more participants of the on-demand communication for the request; and

iii) text that identifies the media content for the on-demand communication of the request.

The media access request message that is formatted in accordance with an SMS message format is referred to below as an SMS-type media access request message. The media access request message that is formatted in accordance with an IM message format is referred to below as an IM-type media access request message. The media access request message that is formatted in accordance with a proprietary IP message format is referred to below as a proprietary-IP-type media access request message.

The subscriber that generates the media access request message (who is referred to below as the “originating subscriber”), is identified from data that is communicated as part of the media access request message. Such data can include the ANI of the mobile telephony device that originated the SMS-type media access request message, the IM screen name/IM Service Provider of the IM-type media access request message, or the source IP address of the proprietary-IP-type media access request message.

The text of i) as described above, which identifies the message as a particular command for requesting on-demand communication, can refer to a short name assigned to the particular command.

The text of ii) as described above, which identifies a given participant for on-demand communication, can refer to the short name for a contact stored in the subscriber's contact list as part of the database 29. Alternatively, the text can represent a phone number for the given participant.

The text of iii) as described above, which identifies the media content for on-demand communication, is a playlist name that is assigned to one or more particular media content item(s) and stored as part of the contact database 29 as described above. The playlist name can be user-assigned (e.g., for user-uploaded media content) or can be service-assigned (e.g., for service-controlled media content) as described above.

In the preferred embodiment, the media access request message encapsulates plain text with a command syntax as follows:
MUSICBLAST <TARGET1> <TARGET2> ... <CONTENT>
   or
VIDEOBLAST <TARGET1> <TARGET2> ... <CONTENT>
where “MUSICBLAST” is the command text field that identifies the message as a particular command requesting on-demand communication of audio content stored in the content database 30, “VIDEOBLAST” is the command text field that identifies the message as a particular command requesting on-demand communication of video content stored in the content database 30, <TARGET1> is text that identifies a participant of the on-demand communication, <TARGET2> is text that identifies another participant of the on-demand communication, and <CONTENT> is text that represents a short name assigned to the media content that is to be used for the on-demand communication.

Note that there can possibly be additional target text fields and at least one target text field required. Also note that additional text field can be provided such as date and time fields for specifying the date and time for the on-demand communication. The target text fields can refer to the short name for a contact stored in the originating subscriber's contact list. Alternatively, the text can represent a phone number for the given participant.

It is also contemplated that the command text field and/or the target text field of the text-based message can be omitted. For example, the target text field can be omitted where there is a particular destination short code or address associated with a particular command, or where the recipient of the on-demand communication is identified from the originating telephone number of the text-based message. In another example, the command text field can be omitted where the content text field implies or is otherwise associated with a certain command or where the recipient short code or other recipient address of the text-based message implies or is otherwise associated with a certain command.

The service includes logic 33 that receives media access request messages over the diverse messaging formats and parses the text embedded in the media access request messages. For media access request messages including a command text field, such parsing extracts the text pertaining to the command and identifies the extracted text as a particular command for requesting on demand communication. For media access request messages including one or more target text fields, such parsing extracts the text pertaining to the participants (e.g., the target field(s)) of the on-demand communication for the request. In the event that the extracted text of a target text field is not a telephone number (i.e., it represents the short name of a participant), the logic 33 accesses the database 29 to retrieve from the originating subscriber's contact list the phone number for the short name represented by the extracted text. The logic 33 also parses the text embedded in the media access request message to identify the content item(s) (e.g., the content field) for the on-demand communication. The logic 33 can also parse the text embedded in the media access request message to identify the date and time (e.g., the date and time fields) for the on-demand communication, if any. The logic 33 then carries out processing that establishes on-demand communication of the content item(s) to the participants of the request.

For a request for on-demand communication of audio content (“MUSICBLAST” request), the on-demand communication is carried out by placing voice calls to the phone number(s) of the participant(s) specified by the request (which is(are) returned from the contact database if specified by short name). Such voice calls are placed immediately in the event that the media access request message does not specify a date and time. Alternatively, the voice calls can be placed at the particular date and time specified by the text of the media access request message. When a given voice call is established (i.e., when the participant answers the voice call), the voice conferencing facility 35 invokes an audio player that plays the audio content item(s) specified by the text of the request over the voice call connection to the participant.

In conjunction with the voice call, the voice conferencing facility 35 can play advertising content or other audio content over the voice call connection to the participant. The voice conferencing facility 35 can also play a header voice message provided by the originating subscriber over the voice call connection to the participant. The header voice message can be recorded by the originating subscriber or possibly encapsulated as text as part of the media access request message forwarded to the service. When encapsulated as text, text-to-speech functionality can be used to convey the header voice message to the participant over the voice call connection to the participant.

When the audio player has completed playing the specified audio content item(s) or at some other time, the voice conferencing facility 35 can invoke interactive voice response functionality to present a menu of options to the participant. The menu options can include any one of the following:
i) replay the played audio content item(s);
ii) play one or more additional audio content items that are related to the played audio content item(s); the related audio content item(s) can share the same artist and/or can be from another artist identified by a matching algorithm or other suitable automatic selection mechanism;
iii) purchase the played audio content item (or a related album or other related audio collection); the purchased audio content item(s) can be stored in the content database 30 and made accessible to the participant over the Internet by the web server 31; alternatively, the purchased audio content item(s) can be downloaded or communicated to another content repository of the participant, or can be stored in an optical storage disk (e.g., CD or DVD disk) and mailed to the participant's designated mailing address;
iv) rate the played audio content item(s); and
v) mark the played audio content item(s) for automatic sharing as described in more detail below.

The voice conferencing facility 35 preferably terminates the voice connection to a given participant(s) upon receiving signaling that indicates such participant has selectively “hung up” the participant's telephony device.

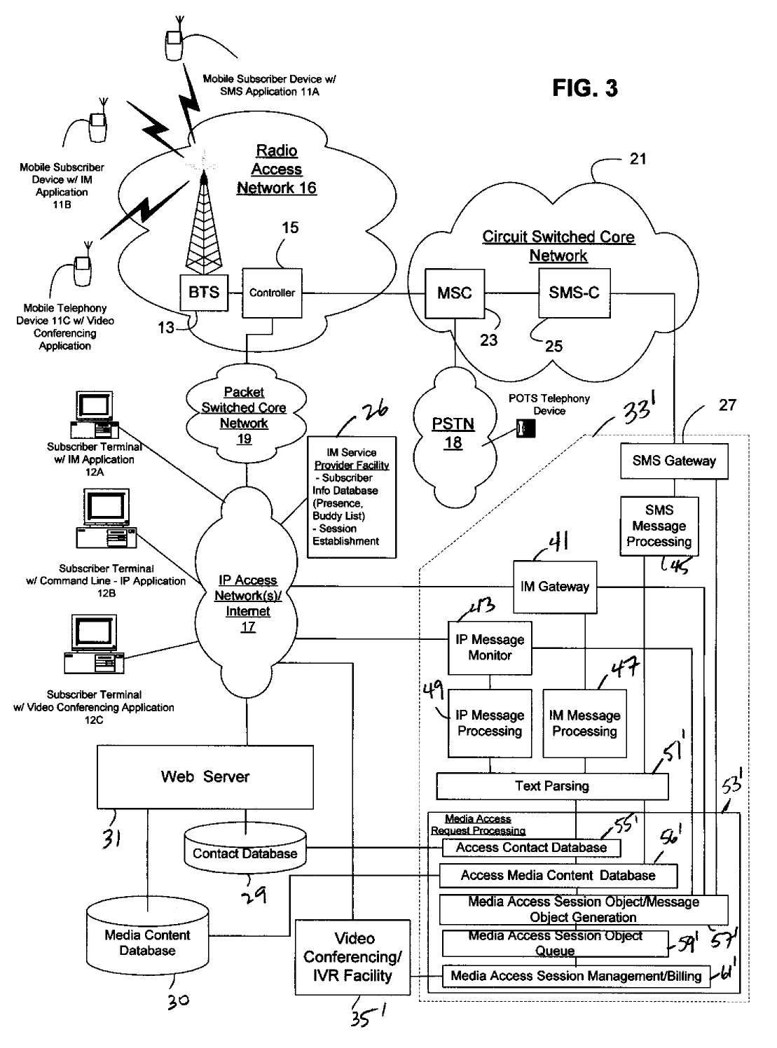

For a request for on-demand communication of video content (“VIDEOBLAST” request), the on-demand communication is carried out by establishing data communication session(s) to the participant(s) of the request (video conferencing facility 35′ of FIG. 3). The data communication session to a given participant is preferably carried out over a peer-to-peer video session in accordance with the SIP and/or H.323 protocols as is well known. This technology is supported by a wide range of commercially-available video-enabled IM applications such as AOL Instant Messenger, Yahoo! Messenger, Skype, Google Talk, Windows Messenger. For these applications, the IM user name and service provider of the given participant is returned from the contact database in the event that the participant is specified by short name. The data communication session(s) for the request is (are) established immediately in the event that the media access request message does not specify a date and time. Alternatively, the data communication session(s) for the request can be established at the particular date and time specified by the text of the media access request message. When the data communication session is established, the voice conferencing facility 35′ streams the video content item(s) specified by the text of the request to the participant over the data communication session.

In conjunction with the data communication session, the video conferencing facility 35′ can stream advertising content or other video content over the data communication session to the participant. The video conferencing facility 35′ can also stream a header media message provided by the originating subscriber over the data communication session to the participant. The header media message, which can be a video stream or solely an audio stream, can be recorded by the originating subscriber or possibly encapsulated as text as part of the media access request message forwarded to the service. When encapsulated as text, text-to-speech functionality can be used to convey the header media message to the participant over the data communication session to the participant.

When the streaming of the media content item(s) of the request has (have) been completed or at some other time, the video conferencing facility 35′ can invoke interactive voice response functionality to present a menu of options to the participant. The menu options can include any one of the following:
i) re-stream the played video content item(s);
ii) stream one or more additional video content items that are related to the played video content item(s); the related video content item(s) can share the same artist and/or can be from another artist identified by a matching algorithm or other suitable automatic selection mechanism;
iii) purchase the played video content item (or a related album or other related audio collection); the purchased video content item(s) can be stored in the content database 30 and made accessible to the participant over the Internet by the web server 31; alternatively, the purchased video content item(s) can be downloaded or communicated to another content repository of the participant, or can be stored in an optical storage disk (e.g., DVD disk) and mailed to the participant's designated mailing address;
iv) rate the played video content item(s); and
v) mark the played video content item(s) for automatic sharing as described in more detail below.

The menu options related to the streamed content item(s) can also be communicated to the participant's communication terminal over the data communication session therebetween and presented to the participant as part of a graphical user interface based thereon.

The voice conference facility 35′ preferably terminates the data communication session to the participant upon receiving signaling that indicates such participant has selectively ended the data communication session.

In the illustrative embodiment of the invention, the logic 33 includes an SMS gateway 27 for receiving (and possibly sending) SMS messages in accordance with one or more SMS messaging formats, an IM gateway 41 for receiving (and possibly sending) IM messages in accordance with one or more IM messaging formats, and an IP Message monitor 43 for receiving (and possibly sending) IP messages in accordance with one or more proprietary IP messaging formats.

The SMS Gateway 27 receives incoming SMS messages that are addressed to a reserved telephone number (or reserved short code) for the service and sends outgoing SMS from the reserved telephone number (or reserved short code) of the service. The SMS gateway 27 interfaces to the SMS-C 25 preferably using a communication protocol such as UCP, SMPP, Sema OIS, or CIMD2 that allows for the communication of SMS messages therebetween. The SMS gateway 27 interfaces to an SMS Message Processing block 45 that processes each given incoming SMS message received at the SMS Gateway 27 to extract the text data encapsulated in the given SMS message and passes the extracted text data to a text parsing engine 51.

The IM Gateway 41 receives incoming IM messages that are addressed to one or more reserved IM user names for the service. The IM messages can also specify corresponding IM service providers. For example kadoink@gmail.com can be used to identify the reserved IM user name “kaDoink” for the service on the Google Talk IM Service. The IM Gateway 41 also sends outgoing IM messages addressed from such reserved IM user name(s) and service provider(s) if need be. The IM Gateway 41 interfaces to one or more IM Service Provider facilities 26 (e.g., facilities for AOL Instant Messenger, Yahoo! Messenger, Skype, Google Talk, Windows Messenger, ICQ, etc.) to maintain presence information as well as for session establishment for sending/receiving messages to/from subscribers of the one or more facilities 26. Such communication can employ proprietary protocols and/or standardized protocols such as XMPP and Jingle as discussed above. The IM Gateway 41 can carry out protocol translation to allow for interoperability between different IM messaging formats and platforms, if need be. The IM Gateway 41 interfaces to an IM Message Processing block 47 that processes each given incoming IM message received at the IM Gateway 41 to extract the text data encapsulated in the given IM message and pass the extracted text data to the text parsing engine 51.

The IP Message Monitor 43 receives incoming IP messages that routed to a predetermined IP address and port, and can also send outgoing IP messages that are routed to a predetermined IP address and port. The IP messages can use TCP or UDP packets as a transport mechanism. The message format for the incoming and outgoing IP messages can be proprietary in nature and known only by the two end points. The IP Message Monitor 43 interfaces to an IP Message Processing block 49 that processes each given IP message received at the IP Message Monitor 43 to extract the text data encapsulated in the given IP message and passes the extracted text data to the text parsing engine 51.

The text parsing engine 51 analyzes the text data to confirm that it begins with text that identifies the message as a particular type for requesting on-demand media content communication by the service. For the preferred command syntax described above, the text parsing engine 51 confirms that the text data begins with “MUSICBLAST” or “VIDEOBLAST”. Upon such confirmation, the text parsing engine 51 analyzes the text data to identify the text that identifies the participant(s) of the request (e.g., target field(s) of the command syntax described above) as well as the text that identifies the content item(s) (e.g., the content field of the command syntax described above). The text parsing engine 51 can also analyze the text data to identify the text that identifies the date and time of the voice call (e.g., the date and time fields of the command syntax described above), if any. The text parsing engine 49 outputs this text along with data identifying the originating subscriber of the voice call request message to Media Access Request Processing block 53.

For “MUSICBLAST” requests, the Media Access Request Processing block 53 includes block 55 that accesses the database 29 to identify the telephone number for each participant (if the participant is not identified by a telephone number within the media access request message). More than one phone number can be stored for a given contact in the originating subscriber's contact list as part of the database 29. In this case, the originating subscriber might possibly specify one of these telephone numbers for use with the service (or more particularly for use in conjunction with media access request messages communicated to the service). Alternatively, presence information for the participant may be used to identify the appropriate telephone number for the participant. In yet another alternative, a rule-based approach that specifies a sequential order amongst the multiple telephone numbers can be used. The processing is then adapted to sequence through the ordered list of telephone numbers for joining the participant to the voice call.

Block 56 accesses the database 29 to identify the reference(s) to the audio content item(s) that matches the text (e.g., playlist name) specified in the content field of the request. Such reference(s) point to the location of the audio content item(s) in the content database 30. Block 56 preferably utilizes such reference(s) to retrieve the audio content item(s) from the content database 30 for storage in a cache or other local data storage. Alternatively, for audio content items that are stored remotely, block 56 utilizes such references to retrieve the audio content item(s) from remote storage for storage in a cache or other local data storage.

Blocks 55 and 56 output to block 57 data that specifies the telephone number(s) of the participants, the audio content item(s), and the date and time of the on-demand communication, if any.

Block 57 generates a Media Access Call Object for each participant of the request, which specifies the participant's telephone number, the audio content item(s) and date and time for the on-demand communication, if any. The Media Access Call Objects are added to the Media Access Call Object Queue 59. If no date and time is specified, the date and time for the object (or a flag corresponding thereto) is set to initiate immediate call setup.

The Media Access Call Object Queue 59 is a queue of Media Access Call Objects that is processed at regular intervals (e.g., every second) to determine if the current date/time matches the date/time for any Media Access Call Object in the queue (or that the call should be set up immediately). If so, the participant's telephone number and the audio content item(s) as specified by the Media Access Call Object are passed to Media Access Call Management Processing block 61, which cooperates with the voice conferencing facility 35 to set up, carry out, and tear down (when complete) a voice call to the telephone number of the participant as dictated the object. When the voice call is established (i.e., when the participant answers the voice call), the voice conferencing facility 35 invokes an audio player that plays the audio content item(s) specified by Media Access Call Object over the voice call connection to the participant. When the audio player has completed playing the specified audio content item(s), the video conferencing facility 35 can invoke interactive voice response functionality to present a menu of options to the participant as described above.

When the voice call is complete, the Media Access Call Management Processing block 61 preferably bills the originating subscriber's account for the voice call.

The telephone number for the participant of the voice call can be to a mobile telephony device, a POTS telephony device, a VOIP communication terminal, or other communication device. It is also possible that the media access call request processing can restrict the voice call to certain telephone numbers based on geographical scope (i.e., not allow international calls) or other constraints.

Block 57 can also cooperate with the SMS Gateway 27 to generate and send an SMS message that is addressed to the participant of the on-demand communication, whereby the SMS message announces the upcoming voice call. If the on-demand communication is to take place at a future date/time, more than one such SMS message can be generated and sent for reminders and announcement. Block 57 can also cooperate with the IM Gateway 41 to generate and send IM messages for announcement and reminders. Block 57 can also cooperate with the IP Message Monitor 43 to generate and send IP messages for announcement and reminders.

Block 57 can also cooperate with the SMS Gateway 27 to exchange one or more SMS messages/replies with the originating subscriber such that the originating subscriber can confirm the particulars of the on-demand communication call. If confirmation is successful, the Media Access Call Object is added to the Media Access Call Object Queue 59; otherwise, the Media Access Call Object is not added to the Media Access Call Object Queue 59. Block 57 can also cooperate with the IM Gateway 41 to exchange one or more IM messages/replies with the originating subscriber such that the originating subscriber can confirm the particulars of the on-demand communication as described above. Block 57 can also cooperate with the IP Message Monitor 43 to exchange one or more IP messages/replies with the originating subscriber such that the originating subscriber can confirm the particulars of the on-demand communication as described above.

Turning now to FIG. 3 which is applicable to the processing of “VIDEOBLAST” request messages, the Media Access Request Processing block 53′ includes block 55′ that accesses the database 29 to identify the contact information for each participant. In the preferred embodiment, the contact information for a given participant includes an IM user name and service provider that can be used to establish a peer-to-peer data communication session to the given participant over a standard protocols such as SIP and/or H.323. This technology is supported by a wide range of commercially-available video-enabled IM applications such as AOL Instant Messenger, Yahoo! Messenger, Skype, Google Talk, and Windows Messenger. More than one IM user name and service provider can be stored for a given contact in the originating subscriber's contact list as part of the database 29. In this case, the originating subscriber might possibly specify one of these IM user names for use with the service (or more particularly for use in conjunction with media access request messages communicated to the service). Alternatively, presence information for the participant may be used to identify the appropriate IM user name for the participant. In yet another alternative, a rule-based approach that specifies a sequential order amongst the multiple IM user names can be used. The processing is then adapted to sequence through the ordered list of IM user names for establishing a data communication session to the participant.

Block 56′ accesses the database 29 to identify the reference(s) to video content item(s) that matches the text (e.g., playlist name) specified in the content field of the request. Such reference(s) point to the location of the video content item(s) in the content database 30. Block 56′ preferably utilizes such reference(s) to retrieve the video content item(s) from the content database 30 for storage in a cache or other local data storage. Alternatively, for video content items that are stored remotely, block 56′ utilizes such references to retrieve the video content item(s) from remote storage for storage in a cache or other local data storage.

Blocks 55′ and 56′ output to block 57′ data that specifies the contact information of the participants, the video content item(s), and the date and time of the on-demand communication, if any.

Block 57′ generates a Media Access Session Object for each participant of the request, which specifies the participant's contact information (e.g., IM user name and service provider), the video content item(s) and date and time for the on-demand communication, if any. The Media Access Session Objects are added to the Media Access Session Object Queue 59′. If no date and time is specified, then the date and time for the object (or a flag corresponding thereto) is set to initiate immediate session setup.

The Media Access Session Object Queue 59 is a queue of Media Access Session Objects that is processed at regular intervals (e.g., every second) to determine if the current date/time matches the date/time for any Media Access Session Object in the queue (or that the session should be set up immediately). If so, the participant's contact information and the video content item(s) as specified by the Media Access Session Object are passed to Media Access Session Management Processing block 61′, which cooperates with the voice conferencing facility 35′ to set up, carry out, and tear down (when complete) a data communication session employing the participant's contact information. In the preferred embodiment, the participant's contact information includes an IM user name and service provider that is used to establish a peer-to-peer data communication session to the given participant over a standard protocols such as SIP and/or H.323. When the data communication session is established, the voice conferencing facility 35′ stream the video content item(s) specified by Media Access Session Object over the data communication session to the participant. When the streaming of the video content item(s) is completed audio, the video conferencing facility 35′ can invoke interactive voice response functionality or other interface means to present a menu of options to the participant over the data communication session as described above.

When the data communication session is complete, the Media Access Session Management Processing block 61′ preferably bills the originating subscriber's account for the on-demand data communication session.

The communications terminal of the participant can be a mobile telephony device, a VOIP communication terminal, or other communication device supporting peer-to-peer data communications. This technology is supported by a wide range of commercially-available video-enabled IM applications such as AOL Instant Messenger, Yahoo! Messenger, Skype, Google Talk, and Windows Messenger. Such technology can be executed on a variety of communication terminals, such as mobile handsets, fixed and mobile computer systems and dedicated IP communication devices. It is also possible that the media access call request processing can restrict the on-demand communications to certain users based on geographical scope (i.e., not allow international calls) or other constraints.

Block 57′ can also cooperate with the SMS Gateway 27 to generate and send an SMS message that is addressed to the participant of the on-demand communication, whereby the SMS message announces the upcoming data communication session. If the on-demand communication is to take place at a future date/time, more than one such SMS message can be generated and sent for reminders and announcement. Block 57′ can also cooperate with the IM Gateway 41 to generate and send IM messages for announcement and reminders. Block 57′ can also cooperate with the IP Message Monitor 43 to generate and send IP messages for announcement and reminders.

Block 57′ can also cooperate with the SMS Gateway 27 to exchange one or more SMS messages/replies with the originating subscriber such that the originating subscriber can confirm the particulars of the on-demand communication call. If confirmation is successful, the Media Access Session Object is added to the Media Access Session Object Queue 59′; otherwise, the Media Access Session Object is not added to the Media Access Session Object Queue 59′. Block 57′ can also cooperate with the IM Gateway 41 to exchange one or more IM messages/replies with the originating subscriber such that the originating subscriber can confirm the particulars of the on-demand communication as described above. Block 57′ can also cooperate with the IP Message Monitor 43 to exchange one or more IP messages/replies with the originating subscriber such that the originating subscriber can confirm the particulars of the on-demand communication as described above.

In the event that an error occurs in the processing of a given media access request message as described above (for example, the text does not conform to the predetermined syntax, the text does not match any contact in the originating subscriber's contact list, or the text does not match any playlist name for the originating subscriber), the generation of a Media Access Call (Session) Object for the request (and subsequent processing of the Media Access Call (Session) Object) are avoided such the voice call (data communication session) is not established for the given call request message. In this case, block 57 (or block 57′ or the other elements of the processing logic 33 or 33′) can cooperate with the SMS Gateway 27 to generate and send one or more SMS messages to the originating subscriber that provides an indication of the error. Block 57 (or block 57′ or the other elements of the processing logic 33 or 33′) can also cooperate with the IM Gateway 41 to generate and send one or more IM messages to the originating subscriber that provides an indication of the error. Block 57′ (or block 57′ or the other elements of the processing logic 33 or 33′) can also cooperate with the IP Message Monitor 43 to generate and send one or more IP messages to the originating subscriber that provides an indication of the error.

As described above, media access request messages can be communicated from a number of different subscriber-operated communication devices which can support a variety of diverse messaging formats and platforms.

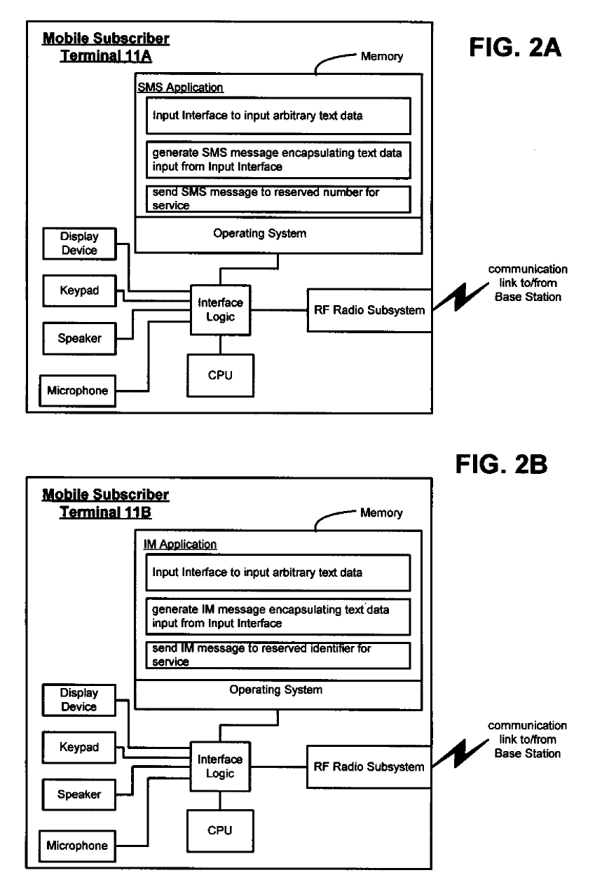

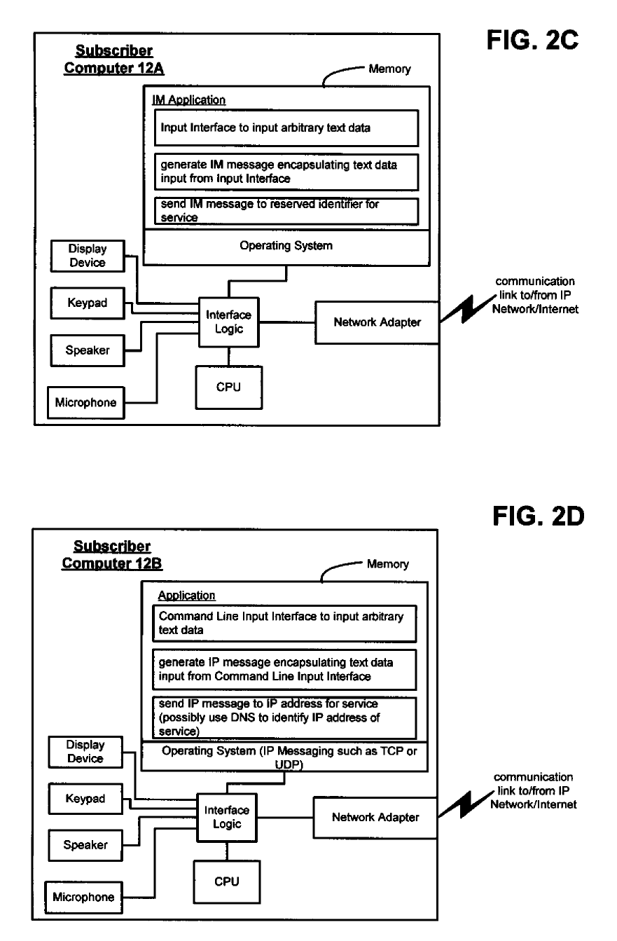

For example, FIG. 2A illustrates the functional block diagram of a mobile telephony device 11A that includes an SMS application for generating SMS-based media access request messages as described above. When executing, the SMS Application is loaded into memory and includes a user interface module 201 that allows the user to input arbitrary text data and to specify the short code reserved for the service as the short code to which the text data is to be sent. Module 203 generates an SMS message directed to the specified short code that encapsulates the text data input by the interface module 201. Such operations are performed in response to the user input (for example, the user pressing a send button or key). Module 205 cooperates with the operating system to send the SMS message generated in module 203 to the reserved short code for the service over the RF radio system of the mobile telephony device 11A. The SMS message is communicated to the base station 13 over a wireless communication link supported by the RF radio subsystem of the mobile telephony device 11A. The SMS message is communicated from the base station 13 to the SMS-C over communication channels therebetween for delivery to the SMS Gateway 27 for processing as described above. The SMS application executing on mobile telephony device 11A also includes functionality to receive SMS messages communicated to the mobile telephony device 11A and to display the received SMS messages on the display screen of the mobile telephony device 11A in response to user input. The SMS application for SMS messaging is typically loaded as an application on most mobile telephony devices. In other environments, it might be hosted on a web site as an applet or other form of executable code and downloaded therefrom for access by subscribers. The SMS application for SMS messaging can also be installed as an application, a toolbar widget or other form of software that executes on a computer system or other communication terminal.

In another example, FIG. 2B illustrates the functional block diagram of a mobile telephony device 11B that includes an IM application for generating IM-based media access request messages as described above. When executing, the IM Application is loaded into memory and includes a user interface module 211 that allows the user to input arbitrary text data and to specify the reserved short name and possibly service provider for the service as the address to which the text data is to be sent. Module 213 generates an IM message directed to the specified address that encapsulates the text data input by the interface module 211. Such operations are performed in response to the user input (for example, the user pressing a send button or key). Module 215 cooperates with the operating system to send the IM message generated in module 213 to the address for the service over the RF radio system of the mobile telephony device 11A. The IM message is communicated to the base station 13 over a wireless communication link supported by the RF radio subsystem of the mobile telephony device 11B. The IM message is communicated from the base station 13 over the packet switched core network 19 and Internet 17 to the IM Gateway 41 for processing as described above. The IM application executing on the mobile telephony device 11B also includes functionality to receive IM messages communicated to the mobile telephony device 11B and to display the received IM messages on the display screen of the mobile telephony device 11B in response to user input. The IM application for IM messaging can be loaded as an application on most mobile telephony devices. It might also be hosted on a web site as an applet or other form of executable code and downloaded therefrom for access by subscribers.

In another example, FIG. 2C illustrates the functional block diagram of a fixed or mobile communication terminal 12A that includes an IM application for generating IM-based media access request messages as described above. When executing, the IM Application is loaded into memory and includes a user interface module 221 that allows the user to input arbitrary text data and to specify the reserved short name and possibly service provider for the service as the address to which the text data is to be sent. Module 223 generates an IM message directed to the specified address that encapsulates the text data input by the interface module 221. Such operations are performed in response to the user input (for example, the user pressing a send button or key). Module 225 cooperates with the operating system to send the IM message generated in module 223 to the address for the service over the communication link to the IP access network/Internet 17 supported by the network adapter of the communication terminal 12A. The IM message is communicated over the IP Access Network/Internet 17 to the IM Gateway 41 for processing as described above. The IM application executing on the communication terminal 12A also includes functionality to receive IM messages communicated to the communication terminal 12A and to display the received IM messages on the display screen of the communication terminal 12A in response to user input. The IM application for IM messaging can be installed as an application, a toolbar widget or other form of software that executes on a computer system or other communication terminal. It might also be hosted on a web site as an applet or other form of executable code and downloaded therefrom for access by subscribers.

In another example, FIG. 2D illustrates the functional block diagram of a fixed or mobile communication terminal 12B that includes a command line application for generating IP-based media access request messages as described above. When executing, the command line application includes a user interface module 231 that allows the user to input arbitrary text data as part of a command line. Module 233 generates an IP message directed to a predetermined IP address and port reserved for the service (and preferably monitored by the IP Message Monitor 43). The IP Message encapsulates the text data input by the interface module 231. Such operations are performed in response to the user input (for example, the user pressing a send button or key). Module 235 cooperates with the operating system to send the IP message generated in module 233 to the IP address and port for the service over the communication link to the IP access network/Internet 17 supported by the network adapter of the communication terminal 12B. The IP message is communicated over the IP Access Network/Internet 17 to the IP Message Monitor 43 for processing as described above. The IP messages can use TCP or UDP packets as a transport mechanism. The message format for the IP messages can be proprietary in nature and known only by the two end points (e.g., communication terminal 12B and IP Message Monitor 43). The command line application executing on the communication terminal 12B also preferably includes functionality to receive IP messages communicated to the communication terminal 12B and to display the received IP messages on the display screen of the communication terminal 12B in response to user input. The command line application for IP messaging can be installed as an application, a toolbar widget or other form of software that executes on a computer system. It can be hosted on a web site as an applet or other form of executable code and downloaded therefrom for access by subscribers.

In order to provide a better understanding of the operation of the telecommunication system of the present invention and parts thereof, the media access request message processing will be illustrated below for examples of the diverse messaging formats described herein. The examples utilize the preferred command syntax “MUSICBLAST <TARGET1> <TARGET2> ... <CONTENT >”. It is assumed that the service has reserved short code “29999” for SMS messaging, kadoink@gmail.com for user name “kaDoink” on the Google Talk IM Service, and IP address “64.147.172.15” and port “51101” for IP messaging. It is also assumed that the originating subscriber has accessed the databases 29 and 30 to include at least the following information:

Subscriber Name: “William Waytena”
ANI of Mobile Telephone for “William Waytena”: 415-555-1213
IM User Name/Service Provider: WillyWay111@gmail.com
Short Name for Contact: JOHN
Telephone Number for Contact “JOHN”: 203-555-5555
IM User Name/Service Provider for Contact John:
oceans11@gmail.com

the following four tracks from the album “A Rush of Blood to the Head” for the artist “Coldplay”, which were uploaded in to the content database 30 by the subscriber “William Waytena”:
“Politik”,
“In My Place”,
“God Put a Smile upon Your Face”, and
“The Scientist;” and

a playlist with a name assigned as “Coldplay” which includes the four tracks above; this playlist is created by the subscriber “William Waytena” and stored in the contact database 29 along with references to the four tracks of the playlist as stored in the content database 30.

### SMS-type Media Access Request Message Processing

The subscriber, “William Waytena”, utilizes an SMS Application operating on a communication terminal (for example, his mobile telephony device with an ANI of 415-555-1213) to generate and send an SMS message to the reserved short code “29997” for the service. The SMS message encapsulates the following plain text: “MUSICBLAST JOHN COLDPLAY”. This SMS message is forwarded to the SMS Gateway 27 for the service (which is adapted to receive SMS messages addressed to the reserved short code “29997” of the service). The SMS Gateway 27 forwards the received SMS message to the SMS Message Processing block 45. The SMS Message Processing block 45 extracts the ANI of the originating mobile subscriber terminal and the text data of the SMS message, and passes this data to the text parsing engine 51. The text parsing engine 51 analyzes the text data to confirm that it starts with “MUSICBLAST”. This confirmation is successful and the text parsing engine 51 continues to analyze the text data to identify “JOHN” as a target field and “COLDPLAY” as the content field. The target field “JOHN” along with the ANI (415-555-1213) of the originating mobile subscriber terminal is passed to the Media Access Request Processing block 53. The Media Access Request Processing block 53 includes block 55 which accesses the Database 29 to identify the telephone number “203-555-5555” for the target field “JOHN” and the references for the audio content items that are part of the matching playlist “COLDPLAY”. The operations of block 55 preferably performs the following:

i) identifies the subscriber “William Waytena” (or an identifier corresponding thereto) for the ANI “415-555-1213” of the originating mobile subscriber terminal;

ii) accesses the contact list for the originating subscriber “William Waytena” to identify the phone number “203-555-5555” for the contact “JOHN” that matches the target field “JOHN”; and

iii) access the playlist(s) for the originating subscriber “William Waytena” in the contact database 29 to identify the playlist named “COLDPLAY” that matches the content field “COLDPLAY” and outputs the references for the audio content that is part of the matching playlist “COLDPLAY” (i.e., references to audio files for the tracks “Politik”, “In My Place”, “God Put a Smile upon Your Face”, and “The Scientist”).

Block 55 passes to block 57 the phone number “203-555-5555” for the contact corresponding to the target field “JOHN” and the references for the four audio files that are part of the matching playlist “COLDPLAY”.

Block 57 generates a Media Access Object that specifies the telephone number “203-555-5555” and the references for the four audio files that are part of the matching playlist “COLDPLAY”, and adds this object to the Media Access Object Queue 59. Because the media access request message did not specify a date and time, the date and time for the on-demand communication (or a flag corresponding thereto) is set to initiate immediate call setup.

The Media Access Object Queue 59 is processed at regular intervals (e.g., every second) to determine if the current date/time matches the date/time for any Media Access Object in the Media Access Object Queue 59 (or that the voice call should be set up immediately). If so, the telephone number and content references of the object are passed to Media Access Call Management Processing block 61. This processing passes the telephone numbers “203-555-5555” and the references for the four audio files that are part of the matching playlist “COLDPLAY” to the Media Access Call Management Processing block 61.

The Media Access Call Management Processing block 61 cooperates with the voice conferencing facility 35 to set up, carry out, and tear down (when complete) a voice call to the telephone numbers “203-555-5555” as dictated by the Media Access Call Object. When the voice call is established (i.e., when the voice call to 203-555-5555 is answered), the voice conferencing facility 35 invokes an audio player that plays the audio content item(s) specified by Media Access Call Object over the voice call connection. When the audio player has completed playing the specified audio content item(s), the video conferencing facility 35 can invoke interactive voice response functionality to present a menu of options to the participant as described above. When the voice call is complete, the Media Access Call Management Processing block 61 preferably bills the account of the originating subscriber (“William Waytena”) for the voice call.

Block 57 can also cooperate with the SMS Gateway 27 to generate and send an SMS message that is addressed to the originating subscriber (to the ANI 415-555-1213 for “William Waytena”) and possibly the other participant(s) of the voice call (to 203-555-5555 for contact “JOHN”), whereby the SMS message announces the upcoming voice call. This announcement message can also be communicated as an IM message to the participant (i.e., the contact “JOHN”) via IM gateway 41. Block 57 can also cooperate with the SMS Gateway 27 to exchange one or more SMS messages/replies with the originating subscriber such that the originating subscriber can confirm the particulars of the media access request. If confirmation is successful, the Media Access Call Object is added to the Media Access Call Object Queue 59; otherwise, the Media Access Call Object is not added to the Media Access Call Object Queue 59.

### IM-type Media Access Call Message Request Processing

The originating subscriber, “William Waytena”, utilizes an IM Application operating on a communication terminal (for example, on his mobile telephony device with an ANI of 415-555-1213) to login in as IM user i, and to generate and send an IM message to the reserved short name for the service (kadoink@gmail.com). The IM message encapsulates the following plain text: ““MUSICBLAST JOHN COLDPALY”. This IM message is forwarded to the IM Gateway 41 for the service (which is adapted to receive IM messages addressed to the reserved short name “kadoink@gmail.com 29999”. The IM Gateway 41 forwards the received IM message to the IM Message Processing block 47. The IM Message Processing block 47 extracts the IM user name and possibly IM service provider of the originating subscriber and the text data of the IM message, and passes this data to the text parsing engine 51. The text parsing engine 51 analyzes the text data to confirm that it starts with “MUSICBLAST”. This confirmation is successful and the text parsing engine 51 continues to analyze the text data to identify “JOHN” as the target field and “COLDPLAY” as the content field. The target field “JOHN”, the content field “COLDPLAY” along with the IM user name and possibly IM service provider of the originating subscriber (“WillyWay111 and gmail.com” ) are passed to the Media Access Request Processing block 53. The Media Access Request Processing block 53 includes block 55 which accesses the Database 29 to identify the telephone number “203-555-5555” for the target field “JOHN” and the references for the audio content items that are part of the matching playlist “COLDPLAY”. The operations of block 55 preferably performs the following:

i) identifies the subscriber “William Waytena” (or an identifier corresponding thereto) for the IM user of the originating subscriber;

iii) accesses the contact list for the originating subscriber “William Waytena” to identify the phone number “203-555-5555” for the contact “JOHN” that matches the target field “JOHN”; and

iii) access the playlist(s) for the originating subscriber “William Waytena” in the contact database 29 to identify the playlist named “COLDPLAY” that matches the content field “COLDPLAY” and outputs the references for the audio content that is part of the matching playlist “COLDPLAY” (i.e., references to audio files for the tracks “Politik”, “In My Place”, “God Put a Smile upon Your Face”, and “The Scientist”).

Block 55 passes to block 57 the phone number “203-555-5555” for the contact corresponding to the target field “JOHN” and the references for the four audio files that are part of the matching playlist “COLDPLAY”.

Block 57 generates a Media Access Object that specifies the telephone number “203-555-5555” and the references for the four audio files that are part of the matching playlist “COLDPLAY”, and adds this object to the Media Access Object Queue 59. Because the media access request message did not specify a date and time, the date and time for the on-demand communication (or a flag corresponding thereto) is set to initiate immediate call setup.

The Media Access Object Queue 59 is processed at regular intervals (e.g., every second) to determine if the current date/time matches the date/time for any Media Access Object in the Media Access Object Queue 59 (or that the voice call should be set up immediately). If so, the telephone number and content references of the object are passed to Media Access Call Management Processing block 61. This processing passes the telephone numbers “203-555-5555” and the references for the four audio files that are part of the matching playlist “COLDPLAY” to the Media Access Call Management Processing block 61.

The Media Access Call Management Processing block 61 cooperates with the voice conferencing facility 35 to set up, carry out, and tear down (when complete) a voice call to the telephone numbers “203-555-5555” as dictated by the Media Access Call Object. When the voice call is established (i.e., when the voice call to 203-555-5555 is answered), the voice conferencing facility 35 invokes an audio player that plays the audio content item(s) specified by Media Access Call Object over the voice call connection. When the audio player has completed playing the specified audio content item(s), the video conferencing facility 35 can invoke interactive voice response functionality to present a menu of options to the participant as described above. When the voice call is complete, the Media Access Call Management Processing block 61 preferably bills the account of the originating subscriber (“William Waytena”) for the voice call.

Block 57 can also cooperate with the IM Gateway 41 to generate and send an IM message that is addressed to the originating subscriber (to WillyWay111@gmail.com) and possibly to the other participant(s) of the voice call (to “oceans111@gmail.com” for contact “JOHN”), whereby the IM message announces the upcoming voice call. This announcement message can also be communicated as an SMS message to the participant (i.e., the contact “JOHN”) via SMS Gateway 27. Block 57 can also cooperate with the IM Gateway 41 to exchange one or more IM messages/replies with the originating subscriber such that the originating subscriber can confirm the particulars of the media access request. If confirmation is successful, the Media Access Call Object is added to the Media Access Call Object Queue 59; otherwise, the Media Access Call Object is not added to the Media Access Call Object Queue 59.

### IP-Type Call Message Request Processing

The originating subscriber, “William Waytena”, utilizes a Command Line IP messaging application operating on a communication terminal (for example, on a communication terminal 12B) to generate and send an IP message to the reserved IP address “64.147.172.15” and port “51101” for the service. The IP message encapsulates the following plain text: “MUSICBLAST JOHN COLDPLAY” and includes data that identifies the originating subscriber. This IP message is forwarded to the IP Message Monitor 43 for the service (which is adapted to receive IP messages addressed to the reserved IP address “64.147.172.15” and port “51101”. The IP Message Monitor 43 forwards the received IP message to the IP Message Processing block 49. The IP Message Processing block 49 extracts the data that identifies the originating subscriber and the text data of the IP message, and passes this data to the text parsing engine 51. The text parsing engine 51 analyzes the text data to confirm that it starts with “MUSICBLAST”. This confirmation is successful and the text parsing engine 51 continues to analyze the text data to identify “JOHN” as the target field and “COLDPLAY” as the content field. The target field “JOHN”, the content field “COLDPLAY” and the data identifying the originating subscriber are passed to the Call Command Processing block 53. The Call Command Processing block 53 includes block 55 which accesses the Database 29 to identify the telephone number “203-555-5555” for the contact “JOHN” that match the target field “JOHN” and the references for the audio content items that are part of the matching playlist “COLDPLAY”. The operations of block 55 preferably performs the following:

i) identifies the subscriber “William Waytena” (or an identifier corresponding thereto) from the identification data passed to block 55;

ii) accesses the contact list for the originating subscriber “William Waytena” to identify the phone number “203-555-5555” for the contact “JOHN” that matches the target field “JOHN”; and

iii) access the playlist(s) for the originating subscriber “William Waytena” in the contact database 29 to identify the playlist named “COLDPLAY” that matches the content field “COLDPLAY” and outputs the references for the audio content that is part of the matching playlist “COLDPLAY” (i.e., references to audio files for the tracks “Politik”, “In My Place”, “God Put a Smile upon Your Face”, and “The Scientist”).

Block 55 passes to block 57 the phone number “203-555-5555” for the contact corresponding to the target field “JOHN” and the references for the four audio files that are part of the matching playlist “COLDPLAY”.

Block 57 generates a Media Access Object that specifies the telephone number “203-555-5555” and the references for the four audio files that are part of the matching playlist “COLDPLAY”, and adds this object to the Media Access Object Queue 59. Because the media access request message did not specify a date and time, the date and time for the on-demand communication (or a flag corresponding thereto) is set to initiate immediate call setup.

The Media Access Object Queue 59 is processed at regular intervals (e.g., every second) to determine if the current date/time matches the date/time for any Media Access Object in the Media Access Object Queue 59 (or that the voice call should be set up immediately). If so, the telephone number and content references of the object are passed to Media Access Call Management Processing block 61. This processing passes the telephone numbers “203-555-5555” and the references for the four audio files that are part of the matching playlist “COLDPLAY” to the Media Access Call Management Processing block 61.

The Media Access Call Management Processing block 61 cooperates with the voice conferencing facility 35 to set up, carry out, and tear down (when complete) a voice call to the telephone numbers “203-555-5555” as dictated by the Media Access Call Object. When the voice call is established (i.e., when the voice call to 203-555-5555 is answered), the voice conferencing facility 35 invokes an audio player that plays the audio content item(s) specified by Media Access Call Object over the voice call connection. When the audio player has completed playing the specified audio content item(s), the video conferencing facility 35 can invoke interactive voice response functionality to present a menu of options to the participant as described above. When the voice call is complete, the Media Access Call Management Processing block 61 preferably bills the account of the originating subscriber (“William Waytena”) for the voice call.

Block 57 can also cooperate with the IP Message Monitor 43 to generate and return an IP message that is addressed to the originating subscriber, whereby the IP message announces the upcoming voice call. This announcement message can also be communicated as an SMS message or IM message to the participant (i.e., the contact “JOHN”) via SMS Gateway 27 or IM gateway 41, respectively. Block 57 can also cooperate with the IP Message Monitor 43 to exchange one or more IP messages/replies with the originating subscriber such that the originating subscriber can confirm the particulars of the voice call. If confirmation is successful, the Call Object is added to the Call Object Queue 59; otherwise, the Call Object is not added to the Call Object Queue 59.

Similar processing can be carried by the logic 33′ of FIG. 3 in order to carry out on-demand communication of video content. For example, the command syntax “VIDEOBLAST <TARGET1> <TARGET2> ... <CONTENT >” can be used to carry out the on-demand communication of the video content associated with the text of the content field to one or more participants associated with the text of the target field(s). The voice conferencing facility 35′ is used to set up, carry out, and tear down (when complete) a data communication session to each participant as specified by the target field(s) of the message. In the preferred embodiment, the participant's contact information includes an IM user name and service provider that is used to establish a peer-to-peer data communication session to the given participant over a standard protocols such as SIP and/or H.323. When the data communication session is established, the voice conferencing facility 35′ streams the video content item(s) specified by the content field of the request over the data communication session to the participant. When the streaming of the video content item(s) is completed audio, the video conferencing facility 35′ can invoke interactive voice response functionality or other interface means to present a menu of options to the participant over the data communication session as described above.

As noted above, the media access request messages can include a date and time fields that specify a particular date and time for the on-demand communication. The text of such date and time fields can have different alpha-numeric format such as “9/1/06 9 am”, “9/1/06 9a”, “9 am 9/1/06”, “9a 9/1/06”, “9a 9/1” where 2006 as the current year is implied, “9/1 9a” where 2006 as the current year is implied, “9 am” for the current date,“9 am Sat”, “Sat 9 am”, “9a Sat”, “Sat 9a”, “15 m” or “15m” or “15 minutes” for 15 minutes later than the current date and time, or “2 hours” or “2h” or “2 h” for 2 hours later than the current date and time. In these cases, the processing logic 33 or 33′ is adapted to interpret these text fields to generate data for the date and time that corresponds thereto and associate such data with the corresponding Media Access Call/Session Object or other data structure for initiating the on-demand communication to the appropriate participant(s) at the date and time specified by the media access request message.

In other alternate embodiments, a subscriber can assign one or more contacts to a group with a specified group name. One or more target fields of the media access request message can include text corresponding to a group name. In this case, the media access request message processing establishes (or attempts to establish) communication to all of the members of the group that matches the group name specified by the target field.

The database 29 (or other data storage means) can maintain a list (or other data structure) of scheduled media access communications pertaining to a given subscriber, wherein the given subscriber is the originating subscriber for each scheduled communication on the list. The given subscriber can access this list and update any scheduled communication therein. Such updates can include, for example, adding one or more participants, removing one or more participants, changing the date and/or time of the communication, and canceling the communication. The list (or other data structure) of calls can also include scheduled communications pertaining to a given subscriber wherein the given subscriber is a participant of the scheduled communication. For these communications, it is contemplated that the subscriber will be able to view the communications and possibly remove himself/herself as a participant of the communications, but cannot add participants to the communication or cancel the communication (unless the subscriber is the only participant of the communication).

It is also contemplated that the call processing and database functionality as described herein (or parts thereof) can be integrated with other parts of the communication network, such as the IM Service Provider facility 26. It is also contemplated that the request message processing functionality and/or the database functionality as described herein can be part of other systems or separate systems and joined by messaging technology or other distributed processing technology.

It is also contemplated that the context text field of the text-based message can represent other information used as part of the on-demand communication.

For example, the content text field can identify the media content to be accessed as part of the on-demand communication as well as the recipient of such on-demand communication. In such a system, the context text field combines a media content identifier and recipient identifier into one code. The parsing of the text-based message extracts the code. The code is associated with particular media content as well as a recipient for the on-demand communication. The code is used to identify the particular media content and the recipient associated therewith for carrying out the on demand communication as described herein.

In another example, the content text field can identify the media content to be accessed as part of the on-demand communication as well as a command identifier for such on-demand communication. In such a system, the context text field combines a media content identifier and command identifier into one code. The parsing of the text-based message extracts the code. The code is associated with particular media content as well as a command for the on-demand communication. The code is used to identify the particular media content and the command associated therewith for carrying out the on demand communication as described herein.

In yet another example, the content text field can identify the media content to be accessed as part of the on-demand communication, the recipient of such on-demand communication, and a command identifier for such on-demand communication. In such a system, the context text field combines a media content identifier, a recipient identifier and command identifier into one code. The parsing of the text-based message extracts the code. The code is associated with particular media content, a command, and the recipient of the on-demand communication. The code is used to identify the particular media content, the command and the recipient associated therewith for carrying out the on demand communication as described herein.

In another example, any one of the different subscriber-operated communication devices described herein can be used to access a web page. The web page includes a link to a widget (or tag or other data structure) for generating a text-based media access request message as described herein and initiating communication of the text-based media access request message to the service. The media access request message can be an SMS-based message, an IM-based message or an IP-based message as described herein. When the user clicks on the link, the widget is activated. Upon activation, the widget generates a predetermined text-based media access request message as described herein and initiates communication of the predetermined text-based media access request message to the service for carrying out on-demand communication of media content as described herein. The predetermined text-based media access message includes a playlist name or code that refers to media content stored or accessed by the service. The target of the media access request can be identified by a target field of the media access request message, from the source address of the message or from other suitable means. The media access request message is processed as described herein in order to automatically establish communication between the service and the target. The media content referred to by the media access request message is played or streamed to the target as part of such communication.

In yet another example, any one of the different subscriber-operated communication devices described herein can be used to send to the service a text-based message of a predefined format, which does not directly initiate communication of media content by the service but instead causes the service to generate and send a text-based message from the service to a designated recipient. The text-based message sent from the subscriber to the service specifies the designated recipient as well as a playlist name which refers to one or more media content items, and can also include additional text that is forwarded on to the designated recipient. When the designated recipient receives the text-based message sent from the service, the recipient can reply back to the service and include the playlist name as part of the reply. When the service receives the reply, the reply is processed in a manner similar to the media access request message as described above in order to automatically establish communication between the service and the source of the reply (the designated recipient of the original message). The media content referred to by the playlist name of the reply is played or streamed to the source of the reply as part of such communication. In an illustrative embodiment, the text-based message communicated from the subscriber to the service encapsulates plain text with a command syntax as follows: SEND <TARGET> <CONTENT> <OPTIONAL TEXT> where “SEND” is a command text field that identifies the message as a particular command, <TARGET> is text that identifies one or more recipients of a follow-on text message, <CONTENT> is text that represents a playlist name referring to media content stored or accessible by the service, and <OPTIONAL TEXT> is text that can possibly be included in the follow-on message to the recipient(s). This text-based message can be an SMS-based message, an IM-based message or an IP-based message. The service receives the text-based message sent by the subscriber, parses the message to identify it as a “SEND” type message, and then generates and sends a follow-on text message whose destination address corresponds to the <TARGET> field. The follow-on text message includes the <CONTENT>0 field and possibly the <OPTIONAL TEXT> field, if any. The follow-on text-based message can be an SMS-based message, an IM-based message or an IP-based message. When the designated recipient receives the follow-on text-based message sent from the service, the recipient can reply back to the service and include the playlist name of the <CONTENT> field as part of the reply. When the service receives the reply, the reply is processed in a manner similar to the media access request message as described above in order to automatically establish communication between the service and the source of the reply (the designated recipient of the original message). The media content referred to by the playlist name of the reply (which is also referred to by the same playlist name of the <CONTENT> field of the “Send” message) is played or streamed to the source of the reply as part of such communication.

The telecommunication system described herein is advantageous because it allows users to utilizing text-based messages of diverse messaging formats to activate on-demand communication of media content. The text-based messages can refer to names for content items and participants of the on-demand communication. Such names are pre-assigned and centrally stored in a contact database. Generating and sending such text-based messages is quick, easy and convenient. Moreover, centralized connection to the participant(s) of the communication can provide cost benefits to the requester.

There have been described and illustrated herein several embodiments of a method and system for centralized storage of media and for communication of such media activated by real-time messaging. While particular embodiments of the invention have been described, it is not intended that the invention be limited thereto, as it is intended that the invention be as broad in scope as the art will allow and that the specification be read likewise. For example, while particular text-based message syntax have been disclosed, it will be understood that other text-based message syntax can be used. Moreover, while particular data structures have been disclosed, it will be understood that other data structures can be used as well. It will therefore be appreciated by those skilled in the art that yet other modifications could be made to the provided invention without deviating from its spirit and scope as claimed.

What is claimed is:

1. An apparatus for establishing on-demand communication of media content, the apparatus comprising:
at least one database that stores a plurality of identifiers each associated with at least one media content item;
interface means for receiving text-based messages communicated over at least one communication network, each text-based message encapsulating text conforming to a predefined syntax that includes a content text field representing an identifier stored in the at least one database;
message processing means, operably coupled to the interface means, that extracts text from each received text-based message;
a text parsing engine, operably coupled to the message processing means, for parsing the extracted text of a given received text-based message to identify the content text field of the given received text-based message;
means for accessing the at least one database to retrieve at least one reference to a particular media content item associated with the identifier corresponding to the content text field; and
means for establishing communication to at least one receiving party, including means for initiating communication of the particular media content that is referenced by the retrieved reference to the at least on receiving party.

2. An apparatus according to claim 1, wherein:
the at least one database stores short names and associated contact data;
the predefined syntax includes at least one target text field representing a short name stored in the at least one database;
the text parsing engine parses the extracted text of a given received text-based message to identify the at least one target text field of the given received text-based message;
the means for accessing the at least one database is adapted to retrieve contact data whose short name corresponds to the at least one target text field of the given text-based message; and
the means for establishing communication to at least one receiving party utilizes the retrieved contact data for initiating communication of the particular media content to the at least on receiving party.

3. An apparatus according to claim 2, wherein:
the particular media content comprises particular audio content;
the contact data comprises a telephone number associated with a given short name that matches a given target text field of the received text-based message; and
the means for initiating communication of the particular media content retrieves the particular audio content from the at least one database and invokes an audio player that plays the retrieved audio content over a peer-to-peer voice call to the telephone number associated with the given short name.

4. An apparatus according to claim 3, wherein:
the means for establishing communication of the particular media content comprises a central telephony facility that initiates the peer-to-peer voice call to the telephone number associated with the given short name.

5. An apparatus according to claim 2, wherein:
the particular media content comprises particular video content;
the contact data comprises contact information associated with a given short name that matches a given target text field of the received text-based message; and
the means for initiating communication of the particular media content retrieves the particular video content from the at least one database and streams the retrieved video content over a peer-to-peer video conference session established utilized the contact information associated with the given short name.

6. An apparatus according to claim 5, wherein:
the means for establishing communication of the particular media content comprises a central videoconferencing facility that initiates the peer-to-peer video conference session to the contact information associated with the given short name.

7. An apparatus according to claim 2, wherein:
the contact information associated with the given short name comprises an IM user name and service provider.

8. An apparatus according to claim 1, further comprising:
means for accessing and updating the at least one database in accordance with user input communicated over an Internet connection.

9. An apparatus according to claim 8, wherein:
the means for accessing and updating the at least one database comprises an Internet-connected server that provides for user input through user interaction with a web browser.

10. An apparatus according to claim 1, wherein:
the text-based messages have a plurality of diverse messaging formats.

11. An apparatus according to claim 10, wherein:
the plurality of diverse messaging formats include at least SMS-type text-based messages and IM-type text-based messages.

12. An apparatus according to claim 10, wherein:
the plurality of diverse messaging formats include IP-type text-based messages that are addressed to a reserved IP address.

13. An apparatus according to claim 1, wherein:
the at least one database stores playlists for a plurality of users, each playlist including at least an identifier and associated references to audio content uploaded by a given user.

14. An apparatus according to claim 13, wherein:
permissions are used to dictate access control to the audio content uploaded by a given user.

15. An apparatus according to claim 1, wherein:
the at least one database stores playlists each including at least an identifier and associated references to audio content controlled by the service.

16. An apparatus according to claim 15, wherein:
permissions are used to dictate access control to the audio content controlled by the service.

17. An apparatus according to claim 2, wherein:
the at least one database stores contact lists for a plurality of users, each contact list including at least short names and associated telephone numbers for contacts of a given user; and

18. An apparatus according to claim 17, wherein:
the database stores information for each one of a plurality of users, the information including calendar information for a given user.

19. An apparatus according to claim 1, wherein:
said predefined syntax includes at least one command text field representing a predefined command; and
the text parsing engine parses the extracted text of each received text-based message to confirm it includes the at least one command text field therein.

20. An apparatus according to claim 1, wherein:
said predefined syntax includes at least one field specifying a date and time;
the text parsing engine parses the extracted text of a given received text-based message to identify the at least one field specifying a date and time and generates data corresponding thereto; and
the means for establishing communication to the at least one receiving party utilizes the data corresponding to the specified date and time in order to establish such communication on the specified date and time.

21. An apparatus according to claim 1, wherein:
each text-based message is addressed to a predetermined identifier.

22. An apparatus according to claim 21, wherein:
the predetermined identifier is at least one of the following: a reserved telephone number for SMS-type text-based messages, a reserved IM short name and IM Service Provider for IM-type text-based messaging, and a reserved IP address and port for IP-type text-based messages.

23. An apparatus according to claim 22, wherein:
the interface means comprises means for receiving SMS-type text-based messages addressed to the reserved telephone number for SMS-type text-based messages.

24. An apparatus according to claim 22, wherein:
the interface means comprises means for receiving IM-type text-based messages addressed to the reserved IM short name and IM Service Provider for IM-type text-based messages.

25. An apparatus according to claim 22, wherein:
the interface means comprises means for receiving IP-type text-based messages addressed to the reserved IP address and port for IP-type text-based messages.

26. A method for establishing on-demand communication of media content, the method comprising:
storing in at least one database a plurality of identifiers each associated with at least one media content item;
receiving text-based messages communicated over at least one communication network, each text-based message encapsulating text conforming to a predefined syntax that includes a content text field representing an identifier stored in the at least one database;
extracting text from each received text-based message;
parsing the extracted text of a given received text-based message to identify the content text field of the given received text-based message;
accessing the at least one database to retrieve at least one reference to a particular media content item associated with an identifier corresponding to the content text field; and
initiating communication of the particular media content that is referenced by the retrieved reference to the at least on receiving party.

27. A method according to claim 26, wherein:
the at least one database stores short names and associated contact data;
the predefined syntax includes at least one target text field representing a short name stored in the at least one database;
the parsing of the extracted text of a given received text-based message identifies the at least one target text field of the given received text-based message;
the at least one database is accessed to retrieve contact data whose short name corresponds to the at least one target text field of the given text-based message; and
communication is established to at least one receiving party utilizing the retrieved contact data for initiating communication of the particular media content to the at least on receiving party.

28. A method according to claim 27, wherein:
the particular media content comprises particular audio content;
the contact data comprises a telephone number associated with a given short name that matches a given target text field of the received text-based message;
communication to the at least one receiving party is established by a peer-to-peer voice call to the telephone number associated with the given short name; and
initiation of communication of the particular audio content is realized by retrieving the particular audio content from the at least one database and invoking an audio player that plays the retrieved audio content over the peer-to-peer voice call.

29. A method according to claim 28, wherein:
communication to the at least one receiving party is established by a central telephony facility that initiates the peer-to-peer voice call to the telephone number associated with the given short name.

30. A method according to claim 27, wherein:
the particular media content comprises particular video content;
the contact data comprises contact information associated with a given short name that matches a given target text field of the received text-based message;
communication to the at least one receiving party is established by a peer-to-peer video conference session utilizing the contact information associated with the given short name; and
initiation of communication of the particular media content is realized by retrieving the particular video content from the at least one database and streaming the retrieved video content over the peer-to-peer video conference session.

31. A method according to claim 30, wherein:
communication to the at least one receiving part is established by a central videoconferencing facility that initiates the peer-to-peer video conference session to the contact information associated with the given short name.

32. A method according to claim 31, wherein:
the contact information associated with the given short name comprises an IM user name and service provider.

33. A method according to claim 26, further comprising:
accessing and updating the at least one database via user input communicated over an Internet connection.

34. A method according to claim 33, wherein:
the user input is accomplished by user interaction with a web browser.

35. A method according to claim 26, wherein:
the text-based messages have a plurality of diverse messaging formats.

36. A method according to claim 35, wherein:
the plurality of diverse messaging formats include at least SMS-type text-based messages and IM-type text-based messages.

37. A method according to claim 35, wherein:
the plurality of diverse messaging formats include IP-type text-based messages that are addressed to a reserved IP address.

38. A method according to claim 26, wherein:
the at least one database stores playlists for a plurality of users, each playlist including at least an identifier and associated references to audio content uploaded by a given user.

39. A method according to claim 38, wherein:
permissions are used to dictate access control to the audio content uploaded by a given user.

40. A method according to claim 26, wherein:
the at least one database stores playlists each including at least an identifier and associated references to audio content controlled by the service.

41. A method according to claim 40, wherein:
permissions are used to dictate access control to the audio content controlled by the service.

42. A method according to claim 27, wherein:
the at least one database stores contact lists for a plurality of users, each contact list including at least short names and associated telephone numbers for contacts of a given user; and

43. A method according to claim 42, wherein:
the database stores information for each one of a plurality of users, the information including calendar information for a given user.

44. A method according to claim 26, wherein:
said predefined syntax includes at least one command text field representing a predefined command; and
the parsing of the extracted text of each received text-based message confirm it includes the at least one command text field therein.

45. A method according to claim 26, wherein:
said predefined syntax includes at least one field specifying a date and time;
the parsing of the extracted text of a given received text-based message identifies the at least one field specifying a date and time and generates data corresponding thereto; and
communication to the at least one receiving party is established utilizing the data corresponding to the specified date and time in order to establish such communication on the specified date and time.

46. A method according to claim 26, wherein:
each text-based message is addressed to a predetermined identifier.

47. A method according to claim 46, wherein:
the predetermined identifier is at least one of the following: a reserved telephone number for SMS-type text-based messages, a reserved IM short name and IM Service Provider for IM-type text-based messaging, and a reserved IP address and port for IP-type text-based messages.

48. A method according to claim 47, further comprising:
receiving SMS-type text-based messages addressed to the reserved telephone number for SMS-type text-based messages.

49. A method according to claim 47, further comprising:
receiving IM-type text-based messages addressed to the reserved IM short name and IM Service Provider for IM-type text-based messages.

50. A method according to claim 47, further comprising:
receiving IP-type text-based messages addressed to the reserved IP address and port for IP-type text-based messages.
